(19) United States
(12) Patent Application Publication
(10) Pub. No.: US 2011/0137441 A1
(43) Pub. Date: Jun. 9, 2011

(54) METHOD AND APPARATUS OF CONTROLLING DEVICE

(75) Inventor: Sang-jin KIM, Suwon-si (KR)

(73) Assignee: SAMSUNG ELECTRONICS CO., LTD., Suwon-si (KR)

(21) Appl. No.: 12/775,067

(22) Filed: May 6, 2010

(30) Foreign Application Priority Data
Dec. 9, 2009 (KR) 10-2009-0121941

(51) Int. Cl. G06F 17/00; G05B 11/01

(52) U.S. Cl. 700/94; 700/11

(57) ABSTRACT

Provided are a method and apparatus which control a device, the method including: receiving at least two input signals; analyzing at least one of a frequency variation, an energy intensity variation, a duration variation, and an input time interval between the received at least two input signals, and controlling the device to perform an operation corresponding to the received at least two input signals based on a result of the analyzing.

### CROSS-REFERENCE TO RELATED PATENT APPLICATION

This application claims priority from Korean Patent Application No. 10-2009-0121941, filed on Dec. 9, 2009 in the Korean Intellectual Property Office, the disclosure of which is incorporated herein in its entirety by reference.

### BACKGROUND

1. Field

Apparatuses and methods consistent with the exemplary embodiments relate to a method and apparatus of controlling a device.

2. Description of the Related Art

When a related art multimedia portable device is used, a user may push buttons mounted on the device to control an operation of the multimedia device. However, if the user is to directly push the buttons of the device whenever the user controls the multimedia portable device, this may be an inconvenience for the user.

To prevent the inconvenience, a method in which multimedia devices are controlled using a remote control or a voice recognition technology has been proposed.

### SUMMARY

The exemplary embodiments provide a method and apparatus which control a device.

According to an aspect of an exemplary embodiment, there is provided a method of controlling a device, the method including: receiving at least two input signals; analyzing at least one of a frequency variation, an energy intensity variation, a duration variation, and an input time interval between the received at least two input signals; and controlling the device to perform an operation corresponding to the received at least two input signals, based on a result of the analyzing.

The analyzing may include analyzing a variation in respective directions in which the received at least two input signals are received.

The analyzing may further include analyzing a variation of respective distances to positions at which the received at least two input signals are generated.

The analyzing may further include analyzing a respective kind of each of the received at least two input signals.

The at least two input signals may include at least one of a clap, a finger snap, a voice, a knock, and a sound generated by rubbing hands together.

The controlling of the device may be performed based on a database in which are stored control commands generated using at least one of the frequency variation, the energy intensity variation, the duration variation, and the input time interval between the received at least two input signals and device operations corresponding to the control commands.

According to an aspect of another exemplary embodiment, there is provided an apparatus which controls a device, the apparatus including: a receiving part which receives at least two input signals; an analysis part which analyzes at least one of a frequency variation, an energy intensity variation, a duration variation, and an input time interval between the received at least two input signals; and a control part which controls the device to perform an operation corresponding to the received at least two input signals, based on an analysis result of the analysis part.

According to an aspect of another exemplary embodiment, there is provided a computer readable recording medium in which a program for executing a method of controlling a device is recorded, wherein the method includes: receiving at least two input signals; analyzing at least one of a frequency variation, an energy intensity variation, a duration variation, and an input time interval between the received at least two input signals; and controlling the device to perform an operation corresponding to the received at least two input signals, based on a result of the analyzing.

According to an aspect of another exemplary embodiment, there is provided a method of controlling a device, the method including: receiving at least two input signals; analyzing a difference between at least one of physical characteristics and temporal characteristics of the received at least two input signals; and controlling the device to perform an operation corresponding to the received at least two input signals, based on the analyzed difference.

### BRIEF DESCRIPTION OF THE DRAWINGS

The above and other features and advantages will become more apparent by describing in detail exemplary embodiments thereof with reference to the attached drawings in which:

FIG. 1 is a flowchart illustrating a process of controlling a device according to an exemplary embodiment;

FIG. 2 is a flowchart illustrating a process of controlling a device based on an input time interval between input signals according to an exemplary embodiment;

FIG. 3 is a flowchart illustrating a process of controlling a device based on a variation of energy intensity between input signals according to an exemplary embodiment;

FIG. 4 is a flowchart illustrating a process of controlling a device based on a duration variation between input signals according to an exemplary embodiment;

FIG. 5 is a flowchart illustrating a process of controlling a device based on a variation in directions in which input signals are received into the device according to an exemplary embodiment;

FIG. 6 is a flowchart illustrating a process of controlling a device based on a variation in distances from the device to positions at which input signals are generated according to an exemplary embodiment;

FIG. 7 is a view illustrating an apparatus which controls a device according to an exemplary embodiment;

FIG. 8 is a view illustrating an example of a method of controlling a device according to an exemplary embodiment; and

FIG. 9 is a view illustrating another example of a method of controlling a device according to an exemplary embodiment.

### DETAILED DESCRIPTION OF THE EXEMPLARY EMBODIMENTS

The exemplary embodiments will now be described more fully with reference to the accompanying drawings, in which exemplary embodiments are shown. Expressions such as “at least one of,” when preceding a list of elements, modify the entire list of elements and do not modify the individual elements of the list.

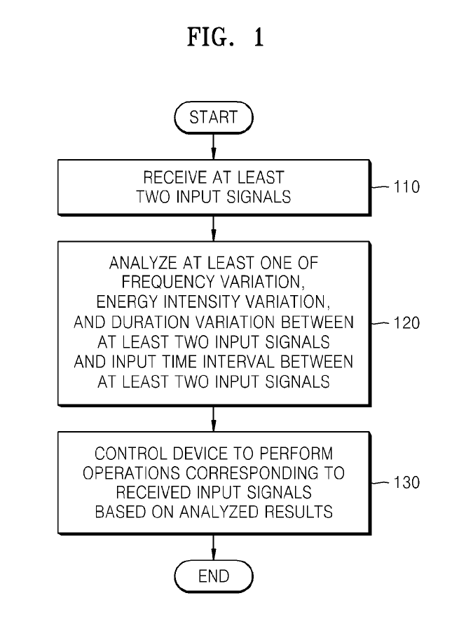

FIG. 1 is a flowchart of a process of controlling a device according to an exemplary embodiment. While not restricted thereto, the device according to an exemplary embodiment may be a mobile device, a multimedia device, a personal computer, a slate device, a notebook computer, etc. Referring to FIG. 1, in operation 110, at least two successive input signals are received. Here, each of the input signals may be, for example, a clap, a snap, a voice, a knock, or a sound of hands rubbing together, though it is understood that another exemplary embodiment is not limited thereto.

In operation 120, at least one of a frequency variation, an energy intensity variation, a duration variation, and an input time interval between the at least two input signals are analyzed. Here, the analysis of the frequency variation between the input signals represents an analysis which determines whether a frequency band corresponding to a second input signal of the at least two successive input signals is higher than a frequency band corresponding to a first input signal of the at least two successive input signals.

For example, a first input signal that is a low tone voice and a second input signal that is a high tone voice may be received in succession, and thus frequencies of the input signals are varied from a low frequency band toward a high frequency band. On the other hand, when the first input signal is a high tone voice and the second input signal is a low tone voice, the frequencies of the input signals are varied from a high frequency band toward a low frequency band.

Also, in another exemplary embodiment, a clap as a first signal and a high tone voice as a second signal may be successively received. In this case, frequencies of the input signals are varied from a low frequency band toward a high frequency band.

However, in the present exemplary embodiment, in which the at least two input signals received are different kinds of signals, in addition to analyzing whether the frequencies of the two input signals are varied from a low frequency band toward a high frequency band or from a high frequency band toward a low frequency band, the method also analyzes whether the high tone voice is inputted after the clap is inputted or whether the clap is inputted after the high tone voice is inputted by detecting a frequency spectrum of the clap (i.e., the first input signal) and a frequency spectrum of the high tone voice (i.e., the second input signal).

In another exemplary embodiment, a variation in directions in which at least two received input signals are received by the device and a variation in distances from the device to positions at which the at least two input signals are generated may be further analyzed.

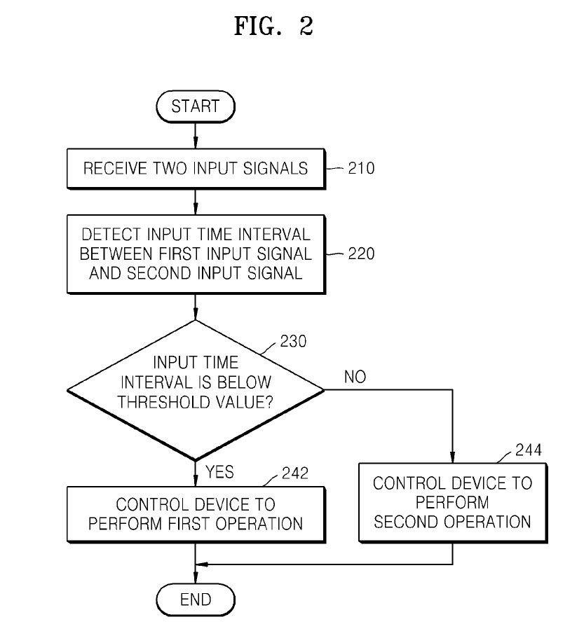

Methods of controlling the device based on the energy intensity variation and the duration variation between the at least two input signals, the input time interval between the at least two input signals, the variation in the directions in which the input signals are received by the device, and the variation in the distances from the device to the positions at which the at least two input signals are generated will be described below with reference to FIGS. 2 to 6.

Referring back to FIG. 1, in operation 130, the device is controlled to perform operations according to the analysis. In an exemplary embodiment, the device may be controlled, for example, based on a database in which are stored control commands generated by using at least one of the frequency variation, the energy intensity variation, and the duration variation between the at least two input signals and the input time interval between the at least two input signals and device operations corresponding to the control commands. That is, when operations corresponding to the at least two input signals are preset and the input signals are received by the device, the device performs the operations corresponding to the received input signals. For example, when a clap is received twice by the device within a relatively short period of time, the device may be preset to display a menu screen.

FIG. 2 is a flowchart illustrating a process of controlling a device based on an input time interval between input signals according to an exemplary embodiment. Referring to FIG. 2, in operation 210, two input signals, for example, a first input signal inputted first into the device and a second input signal inputted second into the device, are received. For convenience of description, although the two input signals are received in the present exemplary embodiment, it is understood that another exemplary embodiment is not limited thereto. For example, as described above, three or more input signals may be received.

In operation 220, an input time interval between the first input signal and the second input signal is detected.

In operation 230, it may be determined whether the detected input time interval between the input signals is less than a predetermined threshold value. For example, when a user generates an “Ah” sound and, a while later, the user generates the “Ah” sound again, it may be determined whether an input time interval between the “Ah” sounds is less than the threshold value. Similarly, for example, in cases where the user generates knocks, claps, finger flicking sounds, etc., it may be determined whether an input time interval between the respective input signals is below the threshold value. Furthermore, as an example, the threshold value may be set to be about 0.1 sec, though it is understood that another exemplary embodiment is not limited thereto.

In operation 242, when the input time interval is less than the predetermined threshold value, the device is controlled to perform a first operation.

In operation 244, when the input time interval exceeds the predetermined threshold value, the device is controlled to perform a second operation.

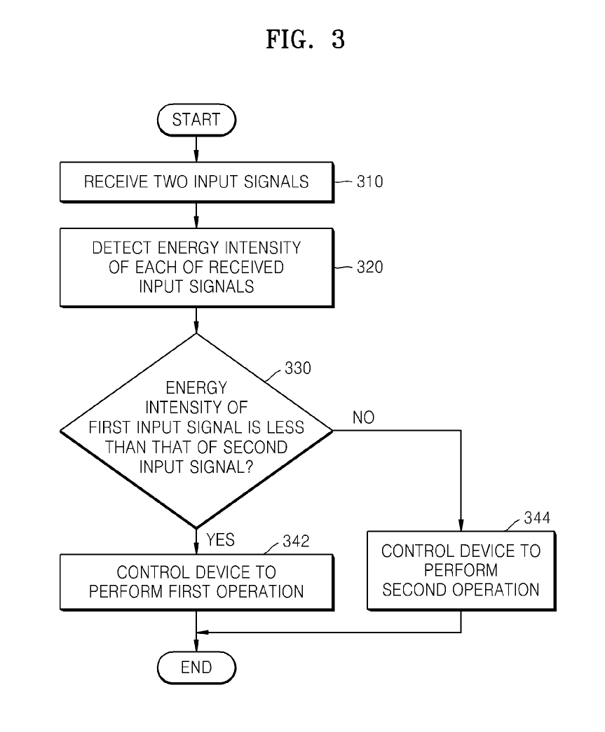

FIG. 3 is a flowchart illustrating a process of controlling a device based on a variation of energy intensity between input signals according to an exemplary embodiment. Referring to FIG. 3, in operation 310, two input signals, for example, a first input signal inputted first into the device and a second input signal inputted second into the device, are received.

In operation 320, an energy intensity of each of the received input signals is detected.

In operation 330, it may be determined whether the energy intensity of the first input signal is less than that of the second input signal. For example, when a user generates a weak “Ah” sound and, thereafter, the user generates a strong “Ah” sound, it may be determined that the first input signal has an energy intensity less than that of the second input signal. Similarly, for example, when the user generates a weak knock and, thereafter, the user generates a strong knock, or when the user generates a weak clap and, thereafter, the user generates a strong clap, it may be determined that the first input signal has an energy intensity less than that of the second input signal. Moreover, for example, if the user generates a clap sound and then moves nearer to the device and generates the same clap sound, the device may determine that the first clap has an energy intensity less than that of the second clap.

In operation 342, when the first input signal has an energy intensity less than that of the second input signal, the device is controlled to perform a first operation.

In operation 344, when the energy intensity of the first input signal is greater than the energy intensity of the second input signal, the device is controlled to perform a second operation.

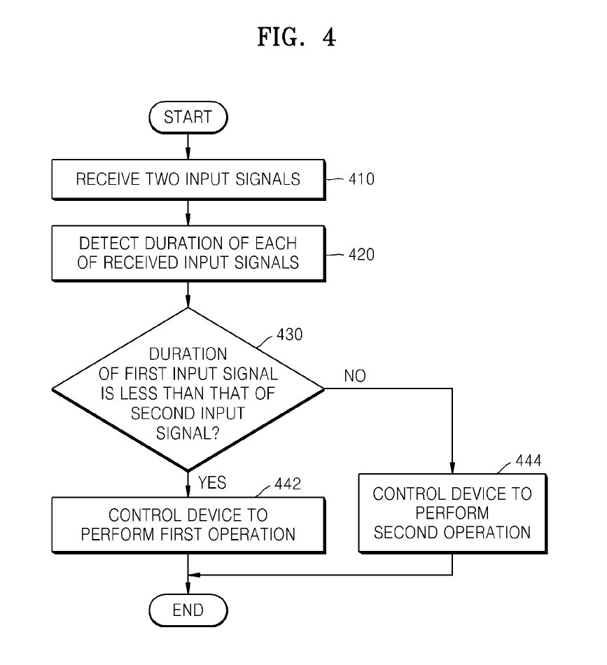

FIG. 4 is a flowchart illustrating a process of controlling a device based on a duration variation between input signals according to an exemplary embodiment. Referring to FIG. 4, in operation 410, two input signals, for example, a first input signal inputted first into the device and a second input signal inputted second into the device, are received.

In operation 420, a duration of each of the received input signals is detected.

In operation 430, it may be determined whether the duration of the first input signal is less than the duration of the second input signal. For example, when the user generates an “Ah” sound for a relatively short period of time, and thereafter, the user generates an “Ah” sound for a relatively long period of time, it may be determined that the first input signal has a duration less than that of the second input signal. Also, for example, when the user generates a short sound such as a nail tap sound and, thereafter, the user generates a scratching sound, the device may determine that the first input signal has a duration less than that of the second input signal.

In operation 442, when the duration of the first input signal is less than the duration of the second input signal, the device is controlled to perform a first operation.

In operation 444, when the duration of the first input signal is greater than the duration of the second input signal, the device is controlled to perform a second operation.

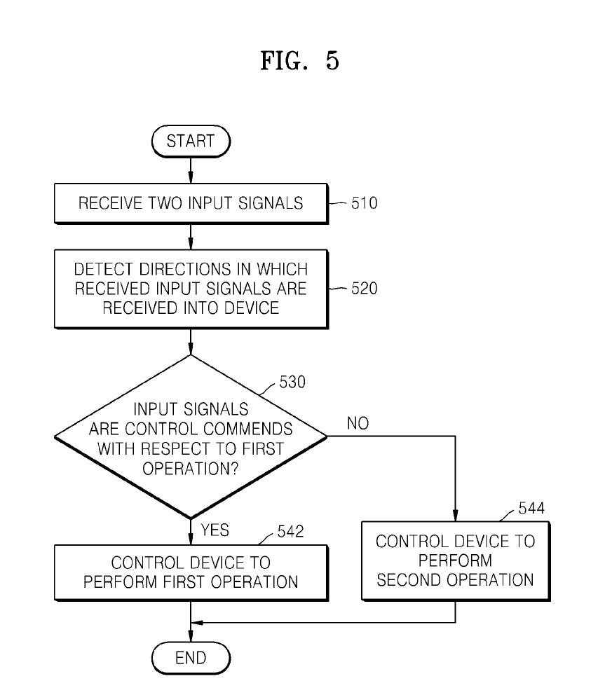

FIG. 5 is a flowchart illustrating a process of controlling a device based on a variation in directions in which input signals are received by the device according to an exemplary embodiment. Referring to FIG. 5, in operation 510, two input signals are received.

In operation 520, a direction in which each of the received input signals is received by the device is detected. Here, when a plurality of microphones is mounted on the device, the directions of the input signals received by the device may be easily detected. For example, if one microphone is disposed at a left side of the device and another microphone is disposed at a right side of the device, when a user claps near the left side of the device, an energy intensity of the clap detected at the right side of the device is less than that of the clap detected at the left side of the device. Therefore, the device may detect the directions in which the input signals are received by the device. Similarly, if the device includes four microphones respectively at upper right, lower right, upper left, and lower left positions, for example, the directions of the input signals received into the device may be easily detected.

In operation 530, the detected results are analyzed to determine whether the input signals correspond to control commands with respect to a first operation of the device or control commands with respect to a second operation of the device.

In operation 542, when it is determined in operation 530 that the received input signals correspond to the control commands with respect to the first operation of the device, the device is controlled to perform the first operation.

In operation 544, when it is determined in operation 530 that the received input signals correspond to the control commands with respect to the second operation of the device, the device is controlled to perform the second operation.

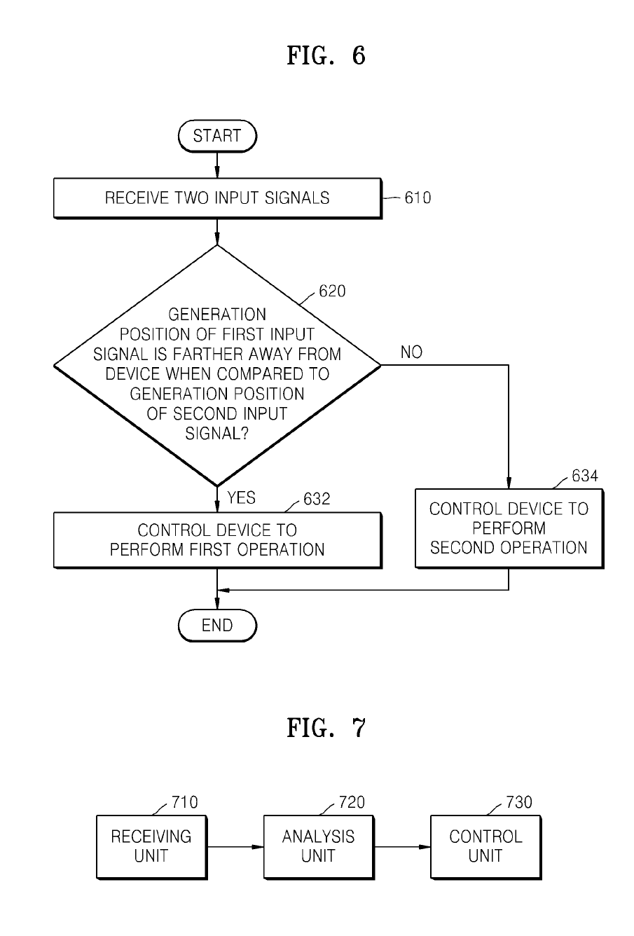

FIG. 6 is a flowchart illustrating a process of controlling a device based on a variation in distances from the device to positions at which input signals are generated according to an exemplary embodiment. Referring to FIG. 6, in operation 610, two input signals, for example, a first input signal inputted first into the device and a second input signal inputted second into the device, are received.

In operation 620, it is determined which of the first input signal and the second input signal is generated further from the device. For example, when the first and second input signals are determined, by analyzing frequency spectrums thereof, to be sounds generated when a user snaps his/her fingers, it may be determined that the first input signal is generated farther away from the device than the second input signal by determining that the first input signal has a lower energy intensity than the energy intensity of the second input signal by assuming that it is difficult to minutely adjust the intensity of sound generated when the user snaps their finger.

In another exemplary embodiment, if the device may directly detect a distance from the device to the generation position of the first input signal and a distance from the device to the generation position of the second input signal without detecting the energy intensities of the input signals, the device may compare the respective distances to analyze which generation position is farther away from the device.

In operation 632, if in operation 620 it is determined that the generation position of the first input signal is farther away from the device than the generation position of the second input signal, the device is controlled to perform a first operation.

In operation 634, if in operation 620 it is determined that the generation position of the first input signal is closer to the device than the generation position of the second input signal, the device is controlled to perform a second operation.

As described above, the device may be controlled according to at least one of the following conditions described with reference to FIGS. 2 to 6: the energy intensity variation and duration variation between the input signals, the input time interval between the input signals, the variation in the directions in which the input signals are received by the device, and the variation in the distances from the at least two input signals to the device.

FIG. 7 is a view illustrating an apparatus which controls a device according to an embodiment of the present invention. Referring to FIG. 7, the apparatus which controls the device includes a receiving part 710, an analysis part 720, and a control part 730. Here, it is assumed that the apparatus which controls the device is mounted on the device.

The receiving part 710 receives at least two input signals.

The analysis part 720 analyzes at least one of a frequency variation, an energy intensity variation, a duration variation, and an input time interval between the at least two input signals.

The control part 730 controls the device to perform operations corresponding to the received input signals, based on the analysis of the analysis part 720.

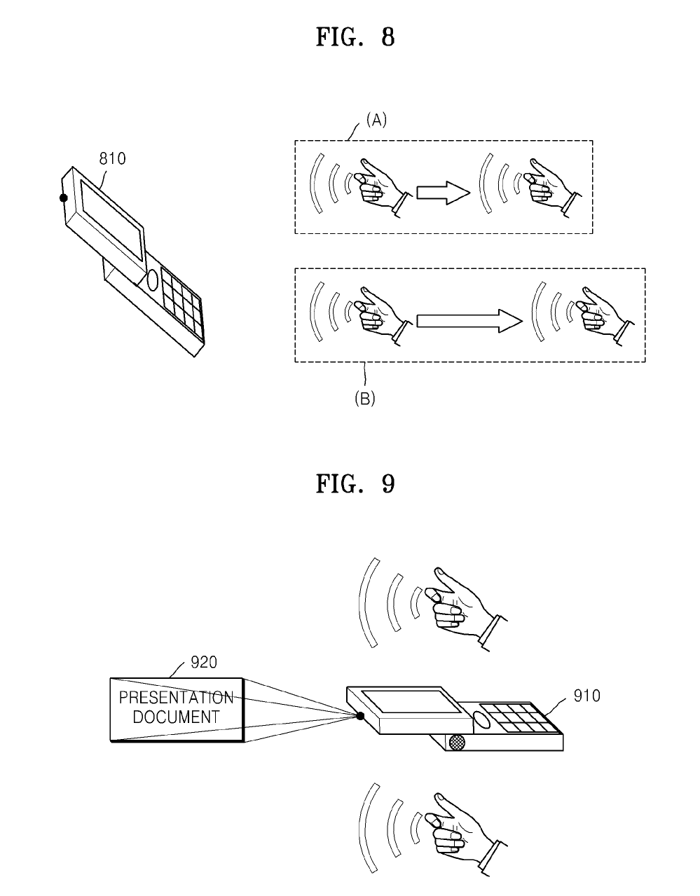

FIG. 8 is a view illustrating an example of a method of controlling a device according to an exemplary embodiment. In particular, FIG. 8 illustrates a case (A) in which an input time interval between two knock sounds inputted into a portable terminal 810 is relatively short and a case (B) in which an input time interval between two knock sounds inputted into the portable terminal 810 is relatively long.

Referring to FIG. 8, if it is assumed that the portable terminal 810 is outputting an E-book, when the user knocks near the portable terminal 810 for a relatively short time, the E-book goes on to the next page. On the other hand, when the user knocks near the portable terminal 810 for a relatively long time, the E-book may return to a previous page.

Accordingly, when the user knocks near the portable terminal 810 when surroundings are noisy, since the knock is inputted near the portable terminal 810, the knock is inputted into the device at a high intensity. Thus, even though the surrounding is noisy, the portable terminal 810 may be controlled regardless of the surrounding noise.

In another exemplary embodiment, when the user taps the portable terminal 810 itself one time using a nail and then scratches the portable terminal 810 for a relatively long time, or when the user taps near the portable terminal 810 one time using a nail and then scratches the portable terminal for a relatively long time, an E-book outputted by the portable terminal 810 may be enlarged.

FIG. 9 is a view illustrating another example of a method of controlling a device according to an exemplary embodiment. Referring to FIG. 9, a portable terminal 910 having a projection function outputs a presentation document 920. In this state, when a user pushes a button of the portable terminal 910, the presentation document 920 being outputted may shake.

In the exemplary embodiment illustrated in FIG. 9, to prevent the presentation document 920 from shaking, when the user knocks on a left side of the portable terminal 910 and then knocks on a right side of the portable terminal 910, the portable terminal 910 may output a following page of the presentation document 920. Also, when the user knocks on the right side of the portable terminal 910 and then knocks on the left side of the portable terminal 910, the portable terminal 910 may output a previous page of the presentation document 920.

In another exemplary embodiment, when the user knocks at a position relatively far from the portable terminal 910 and then knocks at a position relatively close to the portable terminal 910, the portable terminal 910 may output a previous page of the presentation document 920. Also, when the user knocks at a position relatively close to the portable terminal 910 and then knocks at a position relatively far from the portable terminal 910, the portable terminal 910 may output a following page of the presentation document 920.

Although FIGS. 8 and 9 illustrate a process of controlling the portable terminal 910 using knocks, the exemplary embodiments are not limited thereto. For example, the portable terminal 910 may be controlled by using a clap, a sound generated by flicking a finger, a voice, etc. Furthermore, it is understood that the operations of the portable terminal 910 are not to be limited to changing pages of an E-book or presentation document 920. That is, the portable terminal 910 may perform various operations according to input signals received.

While not restricted thereto, the exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs). Also, the exemplary embodiments may be written as computer programs transmitted over a computer-readable transmission medium, such as a carrier wave, and received and implemented in general-use digital computers that execute the programs. Moreover, while not required in all aspects, one or more units of the apparatus illustrated in FIG. 7 can include a processor or microprocessor executing a computer program stored in a computer-readable medium, such as a local storage.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A method of controlling a device, the method comprising:
receiving at least two input signals;
analyzing at least one of a frequency variation, an energy intensity variation, a duration variation, and an input time interval between the received at least two input signals; and
controlling the device to perform an operation corresponding to the received at least two input signals, based on a result of the analyzing.

2. The method of claim 1, wherein the analyzing comprises analyzing a variation in respective directions in which the received at least two input signals are received.

3. The method of claim 2, wherein the analyzing the variation in respective directions in which the received at least two input signals are received comprises analyzing the variation in respective directions in which the received at least two input signals are received using a plurality of microphones.

4. The method of claim 1, wherein the analyzing comprises analyzing a variation of respective distances to positions at which the received at least two input signals are generated.

5. The method of claim 1, wherein the analyzing comprises analyzing a kind of each of the received at least two input signals.

6. The method of claim 1, wherein the received at least two input signals comprise at least one of a clap, a finger snap, a voice, a knock, and a sound generated by rubbing hands together.

7. The method of claim 1, wherein the controlling comprises controlling the device based on a database in which are stored control commands generated using at least one of the frequency variation, the energy intensity variation, the duration variation, and the input time interval between the received at least two input signals and device operations corresponding to the control commands.

8. An apparatus which controls a device, the apparatus comprising:
a receiving part which receives at least two input signals;
an analysis part which analyzes at least one of a frequency variation, an energy intensity variation, a duration variation and an input time interval between the received at least two input signals; and
a control part which controls the device to perform an operation corresponding to the received at least two input signals, based on an analysis result of the analysis part.

9. The apparatus of claim 8, wherein the analysis part analyzes a variation in respective directions in which the received at least two input signals are received.

10. The apparatus of claim 8, wherein the analysis part analyzes a variation in respective distances to positions at which the received at least two input signals are generated.

11. The apparatus of claim 8, wherein the analysis part analyzes a kind of each of the received at least two input signals.

12. The apparatus of claim 8, wherein the received at least two input signals comprise at least one of a clap, a finger snap, a voice, a knock, and a sound generated by rubbing hands together.

13. The apparatus of claim 8, wherein the control part controls the device based on a database in which are stored control commands generated using at least one of the frequency variation, the energy intensity variation, the duration variation, and the input time interval between the received at least two input signals and device operations corresponding to the control commands.

14. The apparatus of claim 8, wherein the receiving part comprises at least one microphone.

15. The apparatus of claim 8, wherein the device is a mobile multimedia device.

16. A method of controlling a device, the method comprising:
receiving at least two input signals;
analyzing a difference between at least one of physical characteristics and temporal characteristics of the received at least two input signals; and
controlling the device to perform an operation corresponding to the received at least two input signals, based on the analyzed difference.

17. The method of claim 16, wherein the at least one of the physical characteristics and the temporal characteristics comprises at least one of a frequency, an energy intensity, a duration, and an input time of the respective input signals.

18. The method of claim 16, wherein the at least one of the physical characteristics and the temporal characteristics comprises at least one of a direction in which the respective input signal is received, a distance to a position in which the respective input signal is generated, and a kind of the respective input signal.

19. A computer readable recording medium in which a program for executing the method of claim 1 is recorded.

20. A computer readable recording medium in which a program for executing the method of claim 16 is recorded.
